(19) United States
(12) Patent Application Publication
(10) Pub. No.: US 2017/0006782 A1
(43) Pub. Date: Jan. 12, 2017

(54) Bouquet Holder for Funerary Applications

(71) Applicant: Denise Riley, Highland Park, TX (US)

(72) Inventor: Denise Riley, Highland Park, TX (US)

(21) Appl. No.: 14/797,081

(22) Filed: Jul. 11, 2015

(51) Int. Cl. A01G 5/04; A01G 9/12

(52) U.S. Cl. CPC A01G 5/04; A01G 9/122

(57) ABSTRACT

The present invention relates to a novel bouquet holder for holding flowers for funerary display purposes. The present invention comprises a linear wire frame with attached circular elements for holding the stems of a bouquet of flowers and a tubular sleeve for covering the stems of the bouquet of flowers. Optionally, a tubular water container may be insinuated over the stems of the bouquet and filled with water. The present bouquet holder further comprises a wire stake allowing the user to mount the bouquet and device at a suitable location on the ground.

### CROSS-REFERENCE TO RELATED APPLICATIONS

This application takes benefit of U.S. Provisional App. 62/024,431, filed Jul. 14, 2014, and incorporates it in its entirety by reference.

### FIELD OF THE INVENTION

The present invention relates to flower-holding devices, more particularly a bouquet holder for holding flowers for funerary display purposes.

### BACKGROUND OF THE INVENTION

Bouquets of flowers—both natural and artificial—are widely used for funerary display purposes. When used at a gravesite, flowers are typically deployed in an urn or flower cone. Urns are typically made of cast metal and useful for permanent or semi-permanent displays. Flower cones are typically made of plastic and are useful for temporary displays such as those in a military cemetery to commemorate Veteran's Day, etc. Since these are often used in large numbers, flower cones must be relatively inexpensive. But, inexpensive flower cones extant in the prior art have the disadvantages of: 1) Lacking a sufficiently long staking device to securely anchor the bouquet in the ground; 2) Not binding the stems of the individual flowers in the bouquet together tightly enough to prevent the bouquet from being torn apart in the wind; and, 3) Not providing a means of hydrating natural flowers for any length of time.

What is needed then is a bouquet holding device for funerary purposes that: 1) Possesses a sufficiently long staking device to ensure that the device and the flowers it contains remain securely in the ground and perpendicular to it; 2) Tightly binds the stems of the flowers in the bouquet together to limit the damage done to the bouquet by wind; and, 3) Offers a receptacle for the stems of a bouquet of natural flowers capable of retaining water.

### SUMMARY OF THE INVENTION

The present bouquet holder is comprised of a linearly disposed wire frame with at least two generally circular, coaxially aligned, concentric elements formed a short distance apart at one end and a wire stake at the other end. The invention further comprises: 1) A closed generally tubular water receptacle that slips inside the circular elements; and, 2) A generally tubular sleeve that slips securely over the circular elements and water receptacle leaving the wire stake exposed.

The invention is used with a bouquet of natural flowers in the following manner: First, the user places the stems of a bouquet of flowers into the closed, tubular water receptacle. Next, the user places the closed, tubular water receptacle though both circular elements of the wire frame such that the flowers and associated foliage extend above the topmost circular element. Next, the user slides the tubular sleeve up over the stake so that it slips over the circular elements and closed, tubular water receptacle leaving the wire stake exposed. This binds the stems of the bouquet firmly together inside the water receptacle and serves as wind foil to limit the damage done to the bouquet by the wind. Next, the user fills the water receptacle with water. Next, the user inserts the wire stake in the ground at the desired location so that the bases of the water receptacle and tubular sleeve are flush with the ground.

The invention is used with a bouquet of artificial flowers in the following manner: First, the user places the stems of the bouquet though both circular elements of the wire frame such that the flowers and associated foliage extend above the topmost circular element. Next, the user slides the tubular sleeve up over the stake so that it slips over the circular elements leaving the wire stake exposed. This binds the stems of the bouquet firmly together inside the circular elements and serves as wind foil to limit the damage done to the bouquet by the wind. Next, the user inserts the wire stake in the ground at the desired location so that the base of the tubular sleeve is flush with the ground.

### BRIEF DESCRIPTION OF THE DRAWINGS

FIG. 1 comprises a side elevation view of the wire frame of preferred embodiment of the present bouquet holder.

FIG. 2 comprises a top plan view of the wire frame of preferred embodiment of the present bouquet holder.

FIG. 3 comprises an isometric view of the wire frame of preferred embodiment of the present bouquet holder.

FIG. 4a comprises an exploded, isometric view of the wire frame and water receptacle of preferred embodiment of the present bouquet holder showing a bouquet of flowers inserted in the water receptacle before the water receptacle is inserted in the wire frame.

FIG. 4b comprises an isometric view of the wire frame and water receptacle of the preferred embodiment of the present bouquet holder showing a bouquet of flowers inserted in the water receptacle after the water receptacle is inserted in the wire frame.

FIG. 5a comprises an isometric view of the wire frame and water receptacle of the preferred embodiment of the present bouquet holder showing a bouquet of flowers inserted in the water receptacle after the water receptacle is inserted in the wire frame and further showing the tubular sleeve of the preferred embodiment of the present bouquet holder and how it is disposed over the wire frame and enclosed water receptacle.

FIG. 5b comprises an isometric view of the wire frame and water receptacle of the preferred embodiment of the present bouquet holder showing a bouquet of flowers inserted in the water receptacle after the water receptacle is inserted in the wire frame and further showing the tubular sleeve of the preferred embodiment of the present bouquet holder disposed over the wire frame and enclosed water receptacle preparatory to use.

FIG. 6 comprises an elevation view of the wire frame and tubular sleeve of preferred embodiment of the present bouquet holder and a bouquet of flowers as in use.

### DETAILED DESCRIPTION OF THE EMBODIMENTS

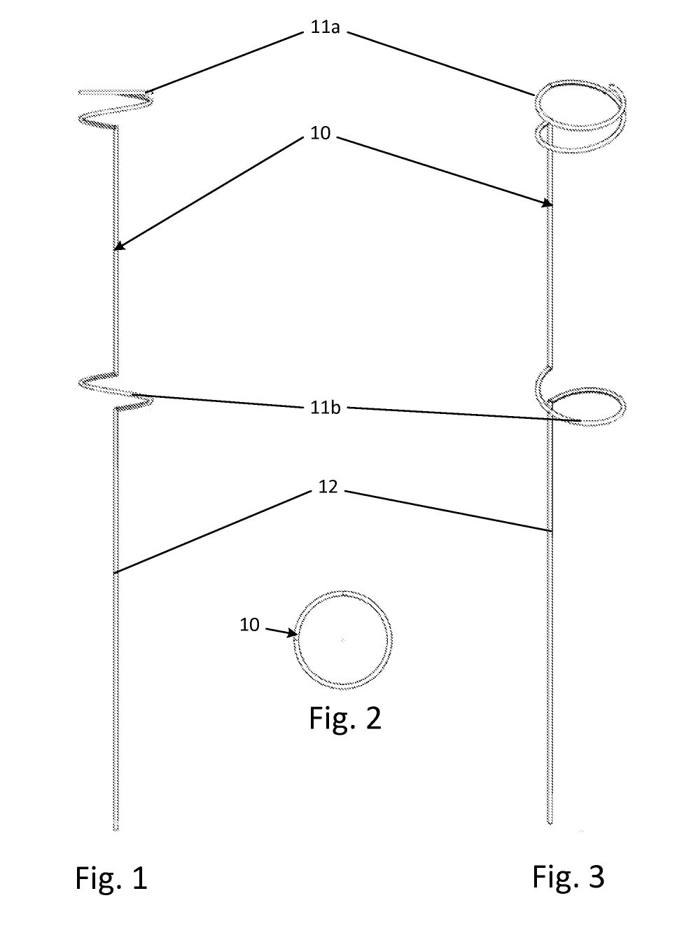

Referring now to FIGS. 1 through 3, a preferred embodiment of wire frame 10 of the present bouquet holder is disclosed. Wire frame 10 is generally linearly disposed along a long axis with at least two generally circular, coaxially aligned, concentric elements 11a and 11b formed at one end. Ordinarily, circular element 11a is formed at the end of wire frame 10 and circular element 11b is formed some distance below it. Circular concentric elements 11a and 11b are coaxially aligned such that the respective planes formed by circular elements 11a and 11b are parallel. Wire frame 10 further comprises collinear wire stake 12 at its terminal end. Coaxial wire stake 12 ranges from 9″ to 21″ in length.

Wire frame 10 is preferably formed of steel wire but it will be readily recognized that numerous other materials including, but not limited to iron, aluminum, and carbon reinforced plastic.

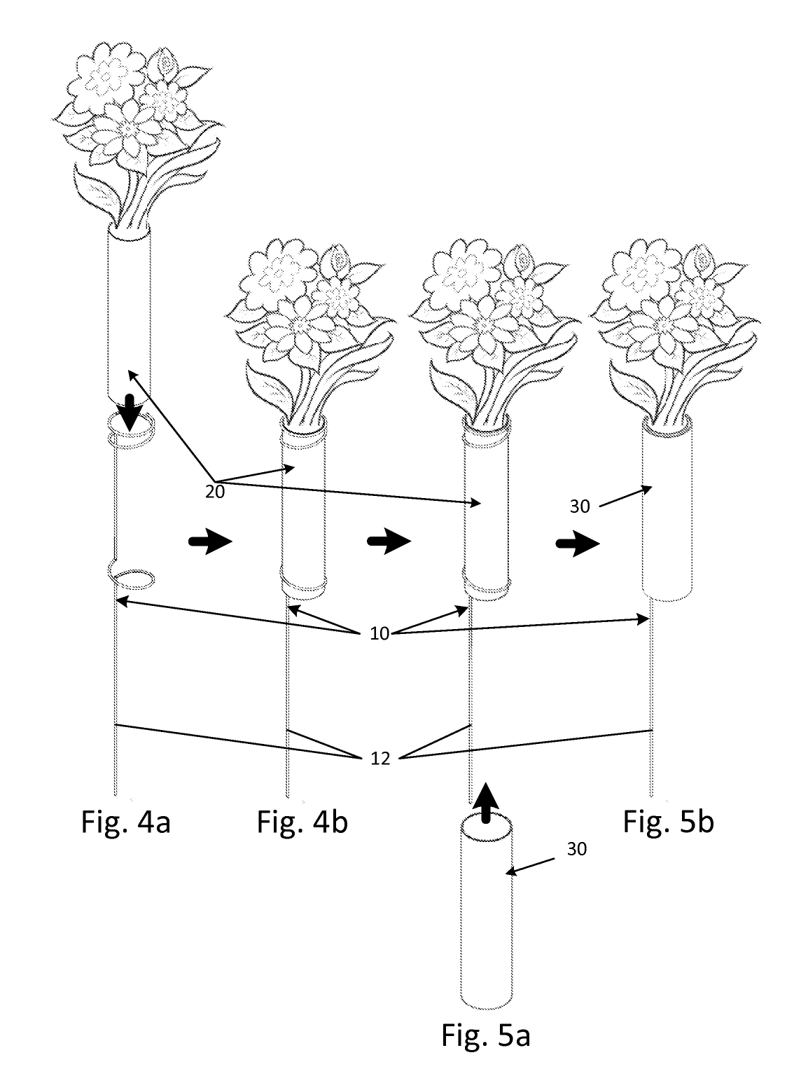

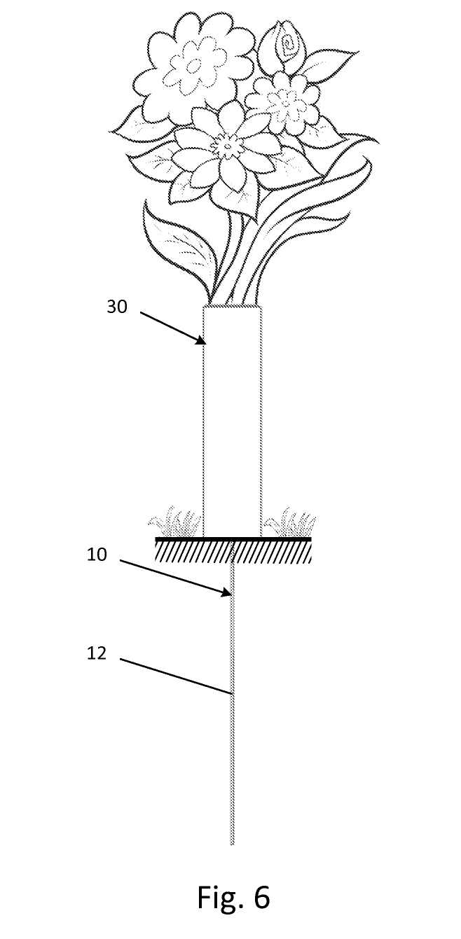

Referring now to FIG. 1 through 6, the device further comprises closed, tubular water receptacle 20 and tubular sleeve 30.

Closed, tubular water receptacle 20 is dimensioned to slide inside circular elements 11a and 11b leaving wire stake 12 exposed. Without limitation, closed, tubular water receptacle 20 is at least as long as the distance between circular elements 11a and 11b. While closed, tubular water receptacle 20 is preferably in the form of a cylinder, it will be readily apparent that closed, tubular water receptacle 20 may be in other shapes and forms. For example, closed, tubular water receptacle 20 may be triangular, square, or pentagonal in cross section. Similarly, closed, tubular water receptacle 20 need not have uniform flat or curved surface definition and thickness. For example, closed, tubular water receptacle 20 may have an uneven longitudinal cross section in the form of an inverted cone. Further, it will be apparent that closed, tubular water receptacle 20 need not be rigid and may be manufactured in the form of a collapsible bag.

Accordingly, while closed, tubular water receptacle 20 is preferably formed of flexible polyethylene or vinyl sheet it will be readily recognized that numerous other materials including, but not limited to, semi-rigid plastic such as polyethylene or polystyrene may be used.

Tubular sleeve 30 is dimensioned to slip securely over circular elements 11a and 11b leaving wire stake 12 exposed. Without limitation, tubular sleeve 30 is at least as long as the distance between circular elements 11a and 11b. While tubular sleeve 30 is preferably in the form of a cylinder, it will be readily apparent that tubular sleeve 30 may be in other shapes and forms. For example, tubular sleeve 30 may be triangular, square, or pentagonal in cross section. Similarly, tubular sleeve 30 need not have uniform flat or curved surface definition and thickness. For example, tubular sleeve 30 may have an uneven longitudinal cross section in the form of an inverted cone. Further, it will be readily apparent that tubular sleeve 30 may be manufactured with or without surface ornamentation and that any such surface ornamentation be integral to, or applied on, the outer surface of tubular sleeve 30 or, in the alternative, may be printed or otherwise rendered on a decorative adhesive sheet or decal that is in turn affixed to the outer surface of tubular sleeve 30.

Tubular sleeve 30 is preferably formed of cardboard or pasteboard but it will be readily recognized that numerous other materials including, but not limited to iron, wood, cloth, and plastic. Cardboard and pasteboard, are particularly advantageous in that they retain moisture thus serving to extend the life of natural flower bouquets when the invention is used without closed, tubular water receptacle 20.

The preferred embodiment of the bouquet holder may be used in the following manner: First, the user places at least one stem of a bouquet of flowers inside closed, tubular water receptacle 20. Next, the user inserts closed, tubular water receptacle 20 linearly though both circular elements 11a and 11b such that the flowers and associated foliage extend above topmost circular element 11a. Next, the user slides tubular sleeve 30 up over wire stake 12 so that it securely slips over the circular elements and inserts closed, tubular water receptacle 20 leaving wire stake 12 exposed. Next, the user fills closed, tubular water receptacle 20 with water. Next, the user inserts wire stake 12 in the ground at the desired location so that the base of tubular sleeve 30 is flush with the ground. This embodiment is optimized for use with natural flowers.

An alternative embodiment of the bouquet holder may be used in the following manner: First, the user places the stems of a bouquet of flowers linearly though both circular elements 11a and 11b such that the flowers and associated foliage extend above topmost circular element 11a. Next, the user slides tubular sleeve 30 up over wire stake 12 so that it securely slips over the circular elements leaving wire stake 12 exposed. Next, the user inserts wire stake 12 in the ground at the desired location so that the base of tubular sleeve 30 is flush with the ground. This embodiment is optimized for use with artificial flowers.

While the present invention has been described in what is thought to be the most useful variants, those skilled in the art will readily recognize that equivalent arrangements are easily constructed. All such variants that seek to alter: 1) The material composition and number of layer of materials comprising tubular sleeve 30; 2) The material composition and number of material comprising wire frame 10; and, 3) The number of circular element 11a and 11b are included in the spirit and scope of the present invention.

What is claimed is:

1. An improved bouquet holder for funerary applications comprising:
a) a substantially linear wire frame further comprising at least two generally circular, coaxially aligned, concentric elements perpendicularly disposed to the longitudinal axis of the linear wire frame;
b) a tubular sleeve securely disposable over the at least two generally circular, coaxially aligned, concentric elements and an interconnecting portion of the wire frame; and
c) a wire stake.

2. An improved bouquet holder for funerary applications of claim 1 further comprising a closed, tubular water container containing water and slidably disposable over at least one stem of a floral bouquet wherein the closed, tubular water container is slidably disposable through the at least two generally circular, coaxially aligned, concentric elements and an interconnecting portion of the wire frame.

3. A method of using an improved bouquet holder for funerary applications comprising the steps of:
a) inserting at least one stem of a bouquet of natural flowers into the tubular water container;
b) inserting the tubular water container through the at least two generally circular, coaxially aligned, concentric elements of the bouquet holder;
c) sliding the tubular sleeve over the at least two generally circular, coaxially aligned, concentric elements of the bouquet holder;
d) filling the tubular water container with water; and
e) inserting the wire stake in the ground at the desired location until the bases of the tubular water container and tubular sleeve is flush with the ground.

4. A method of using an improved bouquet holder for funerary applications comprising the steps of:
a) inserting the stems of a bouquet of flowers through the at least two generally circular, coaxially aligned, concentric elements of the bouquet holder;
b) sliding the tubular sleeve over the at least two generally circular, coaxially aligned, concentric elements of the bouquet holder; and
c) inserting the wire stake in the ground at the desired location until the base of the tubular sleeve is flush with the ground.
